(19) United States
(12) Patent Application Publication
(10) Pub. No.: US 2012/0120227 A1
(43) Pub. Date: May 17, 2012

(54) PANEL CONDUCTIVE FILM CONFIGURATION SYSTEM AND METHOD THEREOF

(76) Inventor: Hsi Ming CHANG, Taoyuan County (TW)

(21) Appl. No.: 13/118,197

(22) Filed: May 27, 2011

(30) Foreign Application Priority Data
Nov. 17, 2010 (TW) 099139527

(51) Int. Cl. H04N 7/18

(52) U.S. Cl. 348/88; 348/E07.085

(57) ABSTRACT

A panel conductive film configuration system and method thereof are presented. A panel is configured with a plurality of groups of lines staggered in different groups, and ends of the lines are arranged in a staggered manner at two different lengths and include a film contact unit. A processing unit analyzes line widths of the groups of lines through images of the panel photographed by a photographing unit, and when configuring a film on the panel, a setting unit controls a configuration position of the film to adjust attachment areas between a plurality of line contact blocks of the film and each film contact unit.

### CROSS-REFERENCE TO RELATED APPLICATION

This application claims the benefit of Taiwan Patent Application No. 099139527, filed on Nov. 17, 2010, which is hereby incorporated by reference for all purposes as if fully set forth herein.

### BACKGROUND OF THE INVENTION

1. Field of Invention

The present invention relates to a panel film configuration system and method, and more particularly to a film configuration system and method for controlling contact areas between line contact blocks of a film and film contact units of a panel according to line widths of each group of lines of the panel.

2. Related Art

FIG. 1A and FIG. 1B are schematic views of line configuration of a panel according to the prior art. A panel 10 is configured with a plurality of groups of lines, in which each group of lines is as shown in FIG. 1B, and a first group of lines 11 and a second group of lines 12 are arranged on the panel 10 with different groups staggered with each other. The bottom of the panel 10 is configured with a terminal section 14, each line is connected to the terminal section 14, and an end of each line is configured with one film contact pad 13.

Subsequently, a film is re-configured on the panel 10, the film includes a plurality of line contact blocks with an equal area, and the contact blocks may respectively contact film contact pads 13 having positions correspond to each other.

However, for a double-track wiring panel, lines in different groups thereof are configured in a staggered manner with different metals. Since the selection of the materials of the first group of lines and the second group of lines and the differences of the control capability of process equipment may cause line widths of the first group of lines and the second group of lines to be different, line impedances of the first group of lines and the second group of lines may differ, which causes that drives of each line and related liquid crystal display (LCD) devices to be different, thereby leading to a situation where dark stripes and bright stripes staggered with each other appear on display pictures.

Hence, how to make picture luminance of the display pictures uniform and avoid generation of staggered dark and bright stripes is a problem that should be considered by manufacturers.

### SUMMARY OF THE INVENTION

The present invention is directed to a panel film assembling system and method for enabling a panel to generate a display picture having stripes with certain luminance regardless of difference between line widths of lines.

In order to solve the problem, the present invention provides a panel conductive film configuration system, comprising a panel, a film, a photographing unit, a setting unit, and a processing unit.

The panel is configured with a plurality of groups of lines that are parallel and configured with different groups adjacent to each other, ends of the lines in different groups are arranged in a staggered manner at two different lengths, and an end of each line is configured with a film contact unit. The film comprises a plurality of line contact blocks with an equal area. The photographing unit is used for photographing line positions to form an image. The setting unit is controlled to configure the film on the panel, so as to enable the line contact blocks to be attached to the film contact units. The processing unit is electrically connected to the photographing unit and the setting unit, analyzes line widths of each group of lines according to the image to obtain a line width difference result, and controls the setting unit according to the line width difference result, so as to adjust an attachment area between the line contact blocks and the film contact units corresponding to each other.

In order to solve the problem of the method, the present invention provides a panel conductive film configuration method, comprising: providing a panel, in which the panel is configured with a plurality of groups of lines that are parallel and configured with different groups adjacent to each other, ends of the lines in different groups are arranged in a staggered manner at two different lengths, and an end of each line is configured with a film contact unit; analyzing line widths of the lines in different groups to obtain a line width difference result; adjusting a position of at least one film according to the line width difference result, so as to adjust attachment areas between a plurality of line contact blocks with an equal area contained therein and the film contact units; and enabling the line contact blocks to be attached to the corresponding film contact units.

The present invention is characterized in that, the present invention adjusts the attachment areas between the line contact blocks and the film contact units to perform impedance compensation actions on lines having higher line impedance values, so as to balance the line impedance of each line and to reduce the difference between the drives of each line and related liquid crystal display (LCD) devices, so as to avoid a situation where dark stripes and bright stripes being staggered appear on display pictures, thereby making picture luminance of the display pictures uniform. Next, even if line widths of lines in different groups are different, the line impedance of each line can be balanced with the line impedance compensation technique of the line, so as to increase the manufacturing yield of products, thereby increasing the process margin and reducing the rejection rate of defective products and semi-finished products.

### BRIEF DESCRIPTION OF THE DRAWINGS

The present invention will become more fully understood from the detailed description given herein below for illustration only, and thus are not limitative of the present invention, and in which:

FIG. 1A and FIG. 1B are schematic views of line configuration of a panel according to the prior art;

FIG. 2 is a schematic view of an architectural of a system according to an embodiment of the present invention;

FIG. 3A to FIG. 3B are schematic views of a first line width difference of a first line configuration according to an embodiment of the present invention;

FIG. 4A to FIG. 4B are schematic views of a second line width difference of the first line configuration according to an embodiment of the present invention;

FIG. 5A to FIG. 5B are schematic views of a third line width difference of the first line configuration according to an embodiment of the present invention;

FIG. 6A to FIG. 6B are schematic views of a first line width difference of a second line configuration according to an embodiment of the present invention;

FIG. 7A to FIG. 7B are schematic views of a second line width difference of the second line configuration according to an embodiment of the present invention;

FIG. 8A to FIG. 8B are schematic views of a third line width difference of the second line configuration according to an embodiment of the present invention;

FIG. 9 is a schematic view of a first line width difference of a third line configuration according to an embodiment of the present invention;

FIG. 10 is a schematic view of a second line width difference of the third line configuration according to an embodiment of the present invention;

FIG. 11 is a schematic view of a third line width difference of the third line configuration according to an embodiment of the present invention;

FIG. 12 is a schematic view of a first line width difference of a fourth line configuration according to an embodiment of the present invention;

FIG. 13 is a schematic view of a second line width difference of the fourth line configuration according to an embodiment of the present invention;

FIG. 14 is a schematic view of a third line width difference of the fourth line configuration according to an embodiment of the present invention;

FIG. 15 is a schematic flow chart of a method according to an embodiment of the present invention; and

FIG. 16 is a detailed schematic flow chart of the method according to the embodiment of the present invention.

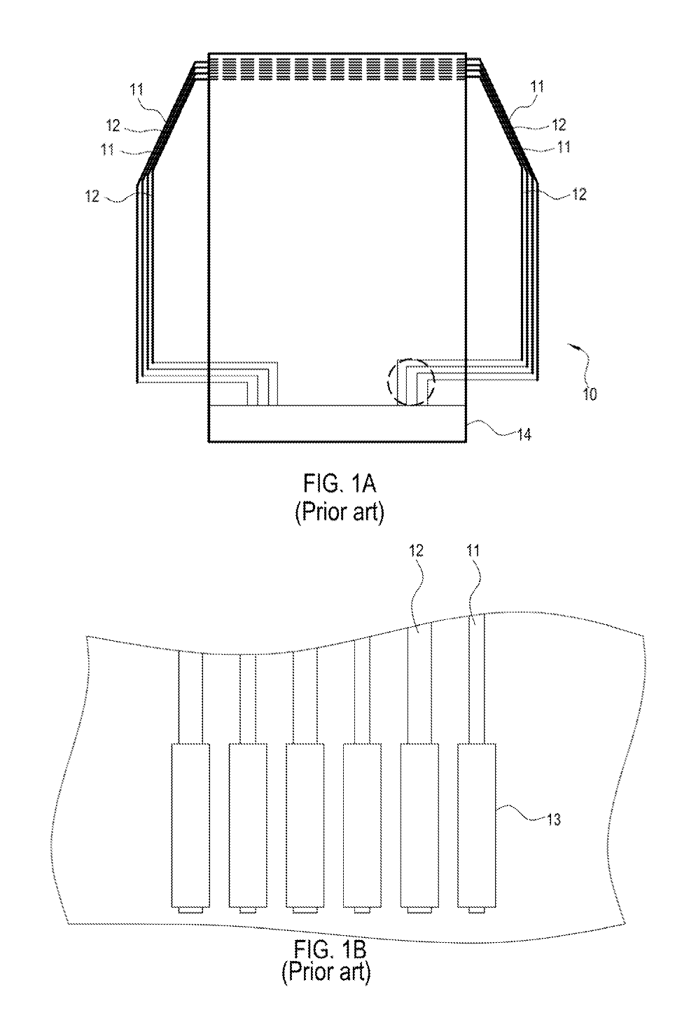

### DETAILED DESCRIPTION OF THE INVENTION

Hereinafter, the details of the embodiments of the present invention will be illustrated with reference to the drawings.

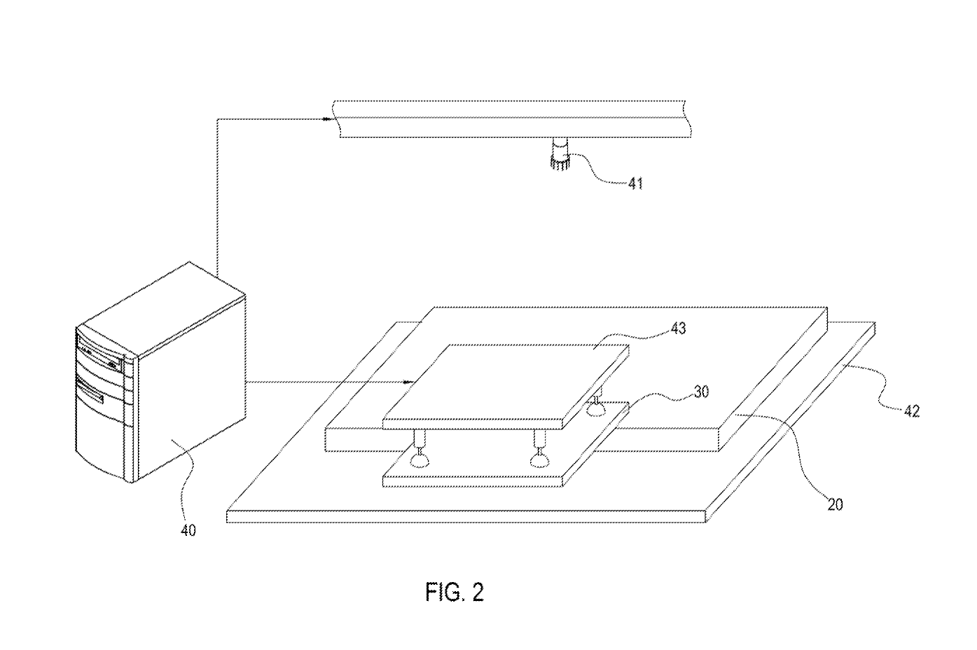

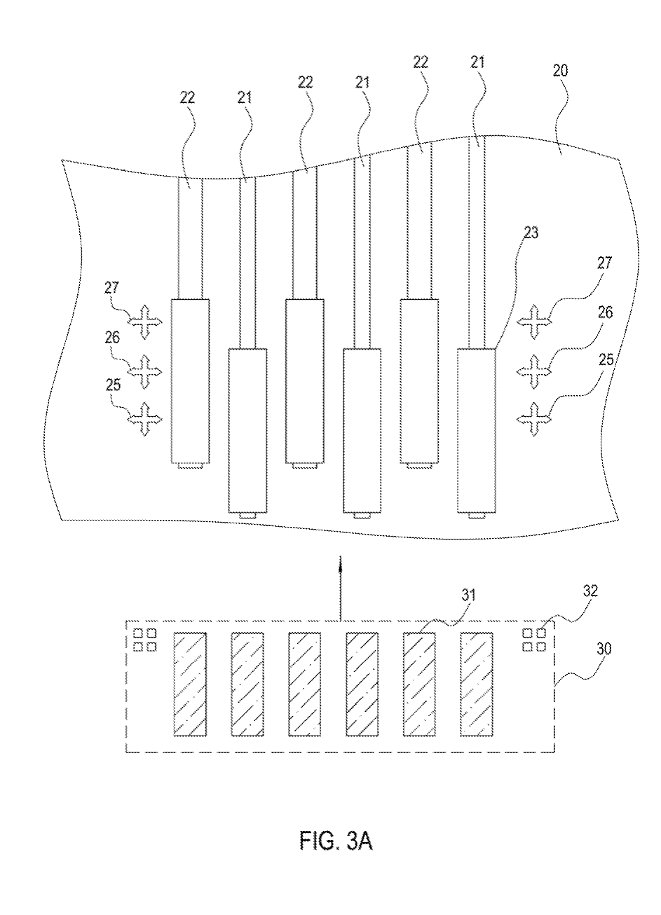

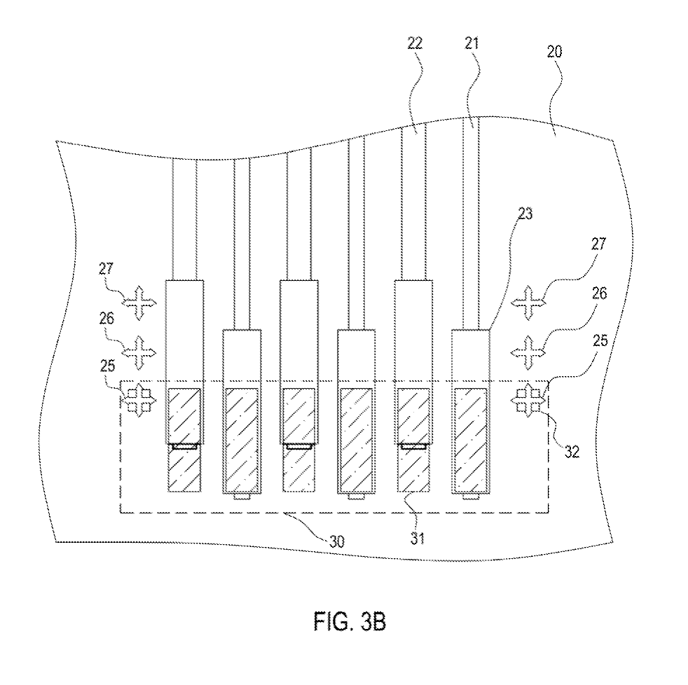

FIG. 2 is a schematic view of an architectural of a system according to an embodiment of the present invention. FIG. 3A to FIG. 3B are schematic views of a first line width difference of a first line configuration according to an embodiment of the present invention.

Referring to FIG. 2 and FIG. 3A, a panel 20 is configured at a bearing table 42, the panel 20 is configured with a plurality of groups of lines that are parallel and configured with different groups adjacent to each other. Here, the first group of lines 21 and the second group of lines 22 are taken as an example for illustration, the lines arranged side by side in a row are taken as an example for illustration, and the end of each line is configured with a film contact unit 23. A setting unit 43 is used for configuring a film 30 on the panel 20, and the film 30 includes a plurality of line contact blocks 31 with an equal shape and area. A photographing unit 41 is configured above the panel 20 for photographing configuration and alignment of the panel 20 and the film 30 to form an image. A processing unit 40 is electrically connected to the photographing unit 41 and the setting unit 43 to obtain an image provided by the photographing unit 41, and analyzes line width differences of each group of lines of the panel 20 in the image, so as to form a line width difference result. After that, the processing unit 40 may control the setting unit 43 to control a configuration position, a displacement distance, and a displacement direction of the film 30 when enabling the setting unit 43 to configure the film 30 on the panel 20, so as to adjust contact areas between the line contact blocks 31 and the film contact units 23.

Referring to FIG. 3A, the panel 20 includes a plurality of reference points, and here, three groups of reference points (25, 26, 27) are taken as an example for illustration. The film 30 is configured with at least one group of alignment marks 32, and here, two alignment marks 32 having symmetrical positions are taken as an example for illustration.

Referring to FIG. 3A and FIG. 3B, in this embodiment, an average line width of the first group of lines 21 is smaller than that of the second group of lines 22, and thus a line impedance value of the first group of lines 21 may be higher than that of the second group of lines 22. Therefore, the processing unit 40 may control the setting unit 43 to adjust displacement of the film 30, so as to enable the two alignment marks 32 to align with a first group of reference points 25 and to enable a contact area between the line contact block 31 and the film contact unit 23 of the first group of lines 21 to be greater than that between the line contact block 31 and the film contact unit 23 of the second group of lines 22, so as to compensate for the line impedance value of the first group of lines 21.

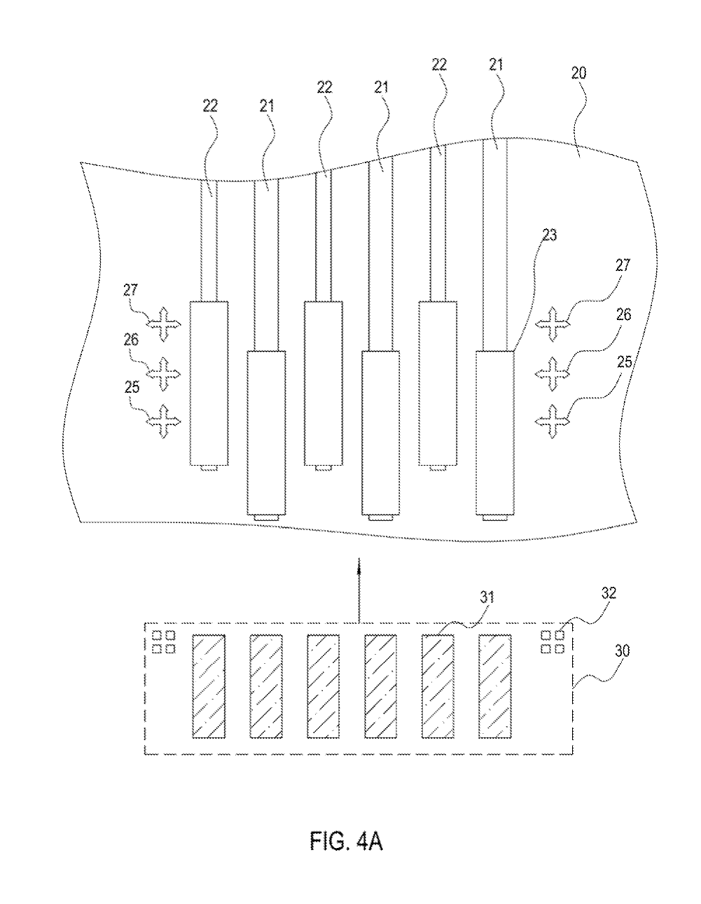

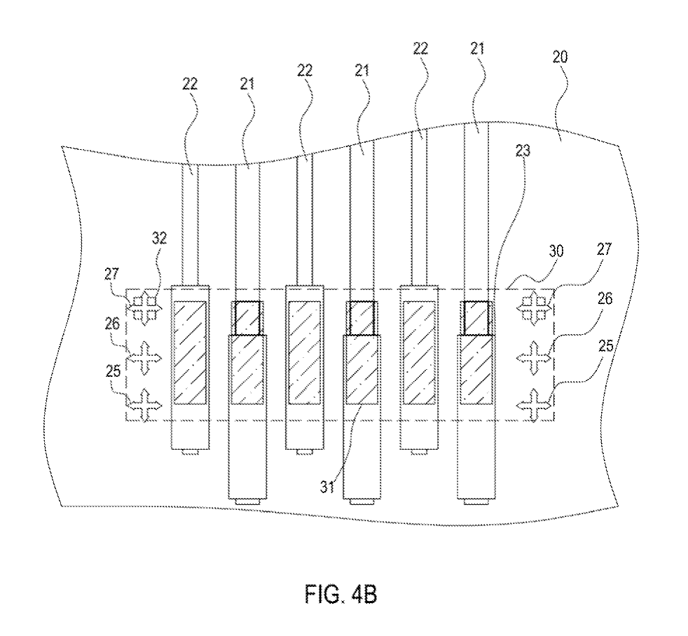

FIG. 4A to FIG. 4B are schematic views of a second line width difference of the first line configuration according to an embodiment of the present invention. Please refer to FIG. 4A to FIG. 4B together with FIG. 2 for ease of understanding.

Referring to FIG. 4A and FIG. 4B, the difference between this embodiment and the previous embodiment lies in that, the average line width of the first group of lines 21 is greater than that of the second group of lines 22, and thus the line impedance value of the first group of lines 21 may be lower than that of the second group of lines 22. Therefore, the processing unit 40 may control the setting unit 43 to adjust the displacement of the film 30, so as to enable the two alignment marks 32 to align with a third group of reference points 27 and to enable the contact area between the line contact block 31 and the film contact unit 23 of the second group of lines 22 to be greater than that between the line contact block 31 and the film contact unit 23 of the first group of lines 21, so as to compensate for the line impedance value of the second group of lines 22.

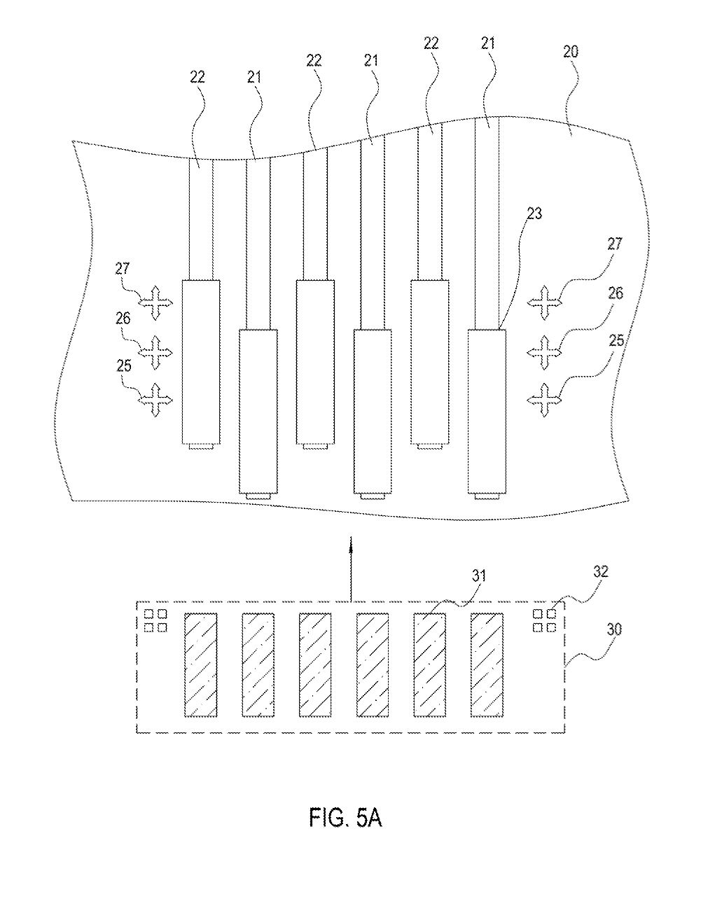

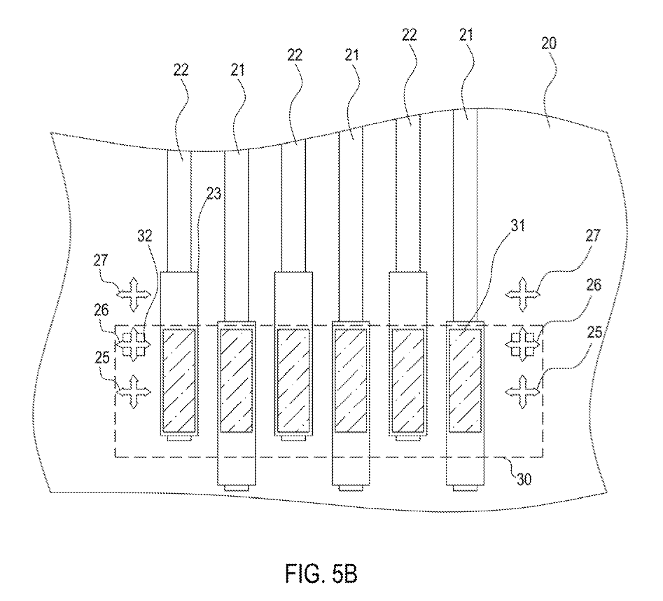

FIG. 5A to FIG. 5B are schematic views of a third line width difference of the first line configuration according to an embodiment of the present invention. Please refer to FIG. 5A to FIG. 5B together with FIG. 2 for ease of understanding.

Referring to FIG. 5A and FIG. 5B, the difference between this embodiment and the previous embodiments lies in that, the average line width of the first group of lines 21 is equal to that of the second group of lines 22, or a line width difference between the average line width of the first group of lines 21 and the average line width of the second group of lines 22 is smaller than a set value, and the line impedance value of the first group of lines 21 may be equal to or close to that of the second group of lines 22. Therefore, the processing unit 40 may control the setting unit 43 to adjust the displacement of the film, so as to enable the two alignment marks 32 to align with a second group of reference points 26 and to enable the contact area between the line contact block 31 and the film contact unit 23 of the second group of lines 22 to be equal to that between the line contact block 31 and the film contact unit 23 of the first group of lines 21.

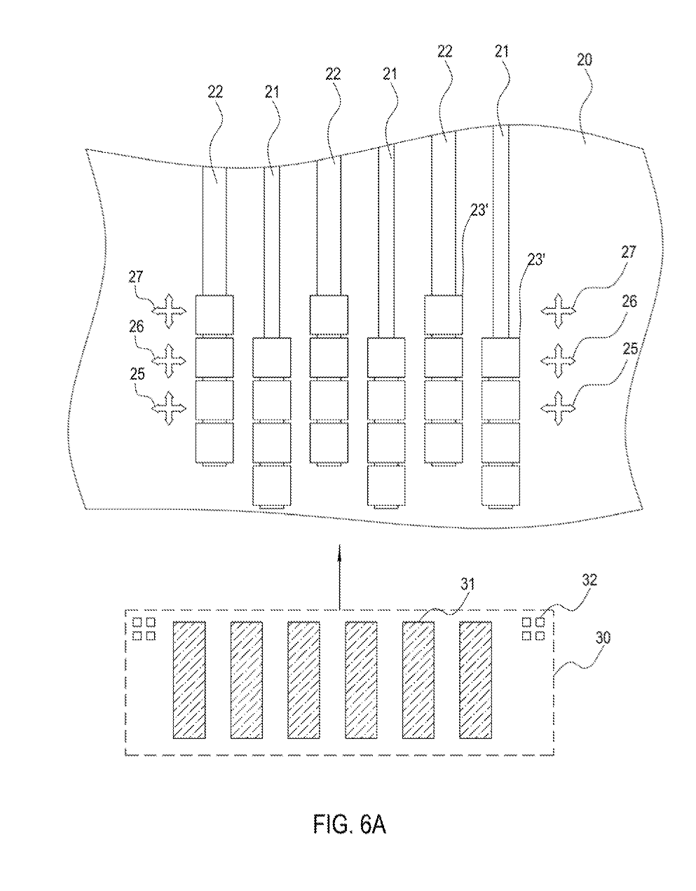

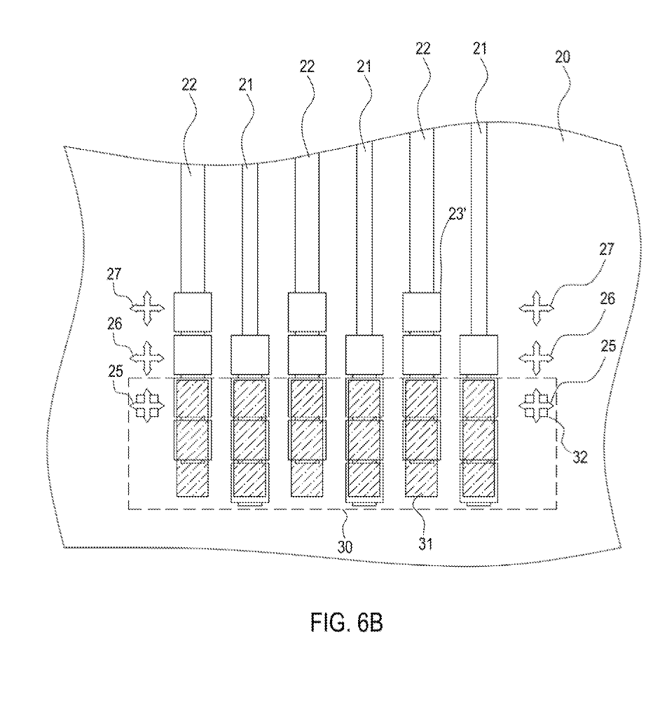

FIG. 6A to FIG. 6B are schematic views of a first line width difference of a second line configuration according to an embodiment of the present invention. Please refer to FIG. 6A to FIG. 6B together with FIG. 2 for ease of understanding.

As shown in FIG. 2 and FIG. 6A, the difference between this embodiment and the previous embodiments lies in that, the film contact unit 23 according to this embodiment includes a plurality of spaced contact pads 23′.

As shown in FIG. 6A, the panel 20 is also configured with a plurality of reference points, and here, three groups of reference points (25, 26, 27) are taken as an example for illustration. The film 30 is configured with at least one group of alignment marks, and here, two alignment marks 32 are taken as an example for illustration.

Referring to FIG. 6A and FIG. 6B, in this embodiment, the average line width of the first group of lines 21 is smaller than that of the second group of lines 22, and thus the line impedance value of the first group of lines 21 may be higher than that of the second group of lines 22. Therefore, the processing unit 40 may control the setting unit 43 to adjust the displacement of the film 30, so as to enable the two alignment marks 32 to align with the first group of reference points 25 and to enable a contact area between the line contact blocks 31 and spaced contact pads 23′ of the first group of lines 21 to be greater than that between the line contact blocks 31 and spaced contact pads 23′ of the second group of lines 22. Referring to FIG. 6B, the line contact block 31 corresponding to the first group of lines 21 is in contact with three spaced contact pads 23′, and the line contact block 31 corresponding to the second group of lines 22 is in contact with two spaced contact pads 23′, so as to compensate for the line impedance value of the first group of lines 21.

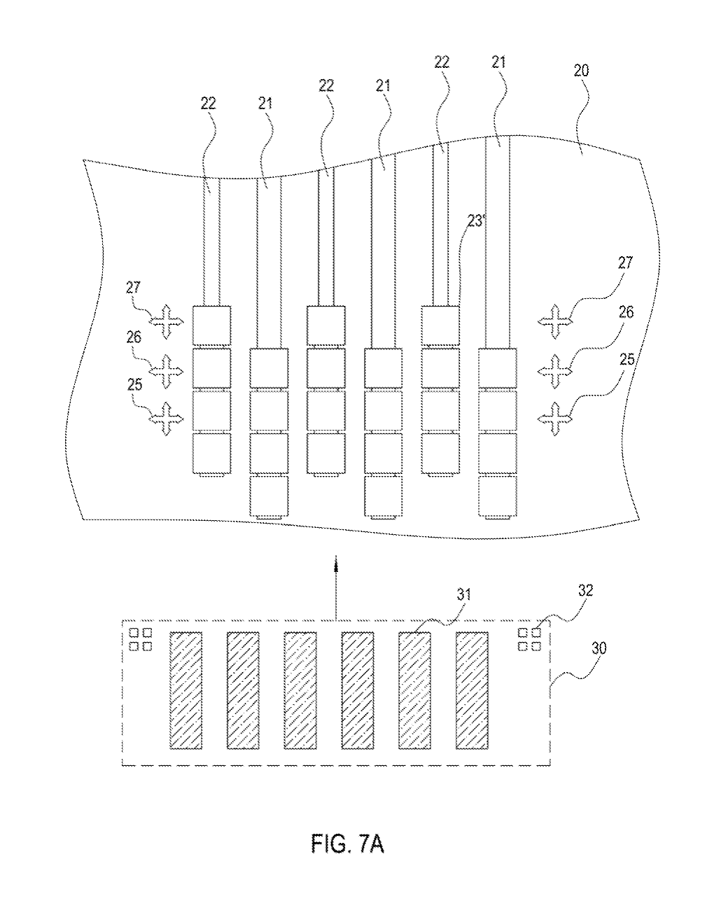

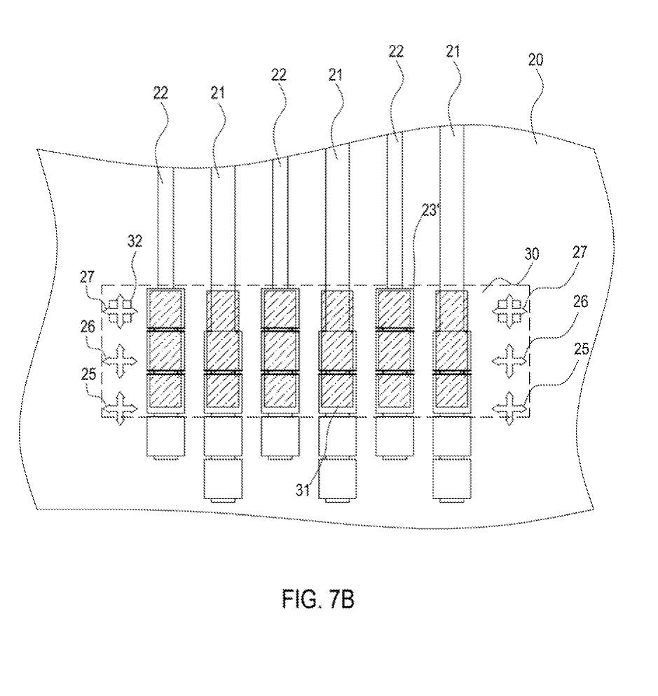

FIG. 7A to FIG. 7B are schematic views of a second line width difference of the second line configuration according to an embodiment of the present invention. Please refer to FIG. 7A to FIG. 7B together with FIG. 2 for ease of understanding.

Referring to FIG. 7A and FIG. 7B, the difference between this embodiment and the previous embodiment lies in that, the average line width of the first group of lines 21 is greater than that of the second group of lines 22, and thus the line impedance value of the first group of lines 21 may be lower than that of the second group of lines 22. Therefore, the processing unit 40 may control the setting unit 43 to adjust the displacement of the film 30, so as to enable the two alignment marks 32 to align with the third group of reference points 27 and to enable the contact area between the line contact blocks 31 and spaced contact pads 23′ of the second group of lines 22 to be greater than that between the line contact blocks 31 and spaced contact pads 23′ of the first group of lines 21. Referring to FIG. 7B, the line contact block 31 corresponding to the first group of lines 21 is in contact with two spaced contact pads 23′, and the line contact block 31 corresponding to the second group of lines 22 is in contact with three spaced contact pads 23′, so as to compensate for the line impedance value of the second group of lines 22.

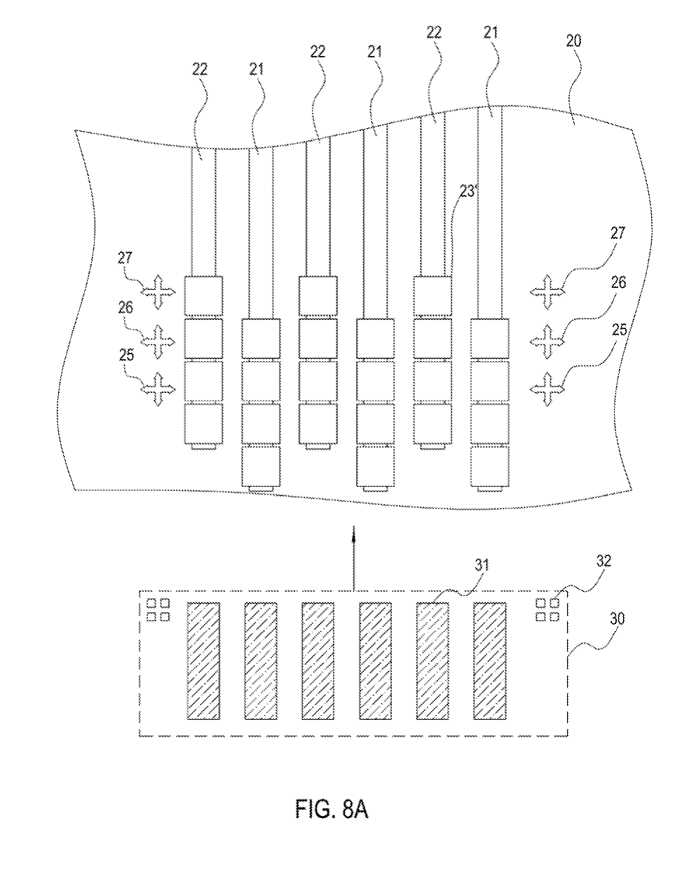

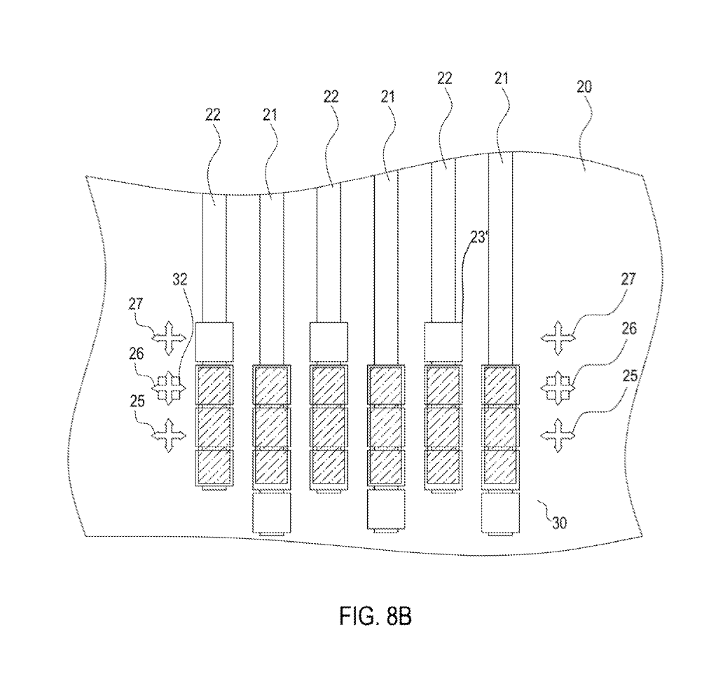

FIG. 8A to FIG. 8B are schematic views of a third line width difference of the second line configuration according to an embodiment of the present invention. Please refer to FIG. 8A to FIG. 8B together with FIG. 2 for ease of understanding.

Referring to FIG. 8A and FIG. 8B, the difference between this embodiment and the previous embodiments lies in that, the average line width of the first group of lines 21 is equal to that of the second group of lines 22, or the line width difference between the average line width of the first group of lines 21 and the average line width of the second group of lines 22 is smaller than a set value, and the line impedance value of the first group of lines 21 may be equal to or close to that of the second group of lines 22. Therefore, the processing unit 40 may control the setting unit 43 to adjust the displacement of the film 30, so as to enable the two alignment marks 32 to align with the second group of reference points 26 and to enable the contact area between the line contact block 31 and spaced contact pads 23′ of the second group of lines 22 to be equal to that between the line contact block 31 and spaced contact pads 23′ of the first group of lines 21. Referring to FIG. 8B, the line contact block 31 corresponding to the first group of lines 21 is in contact with three spaced contact pads 23′, and the line contact block 31 corresponding to the second group of lines 22 is also in contact with three spaced contact pads 23′.

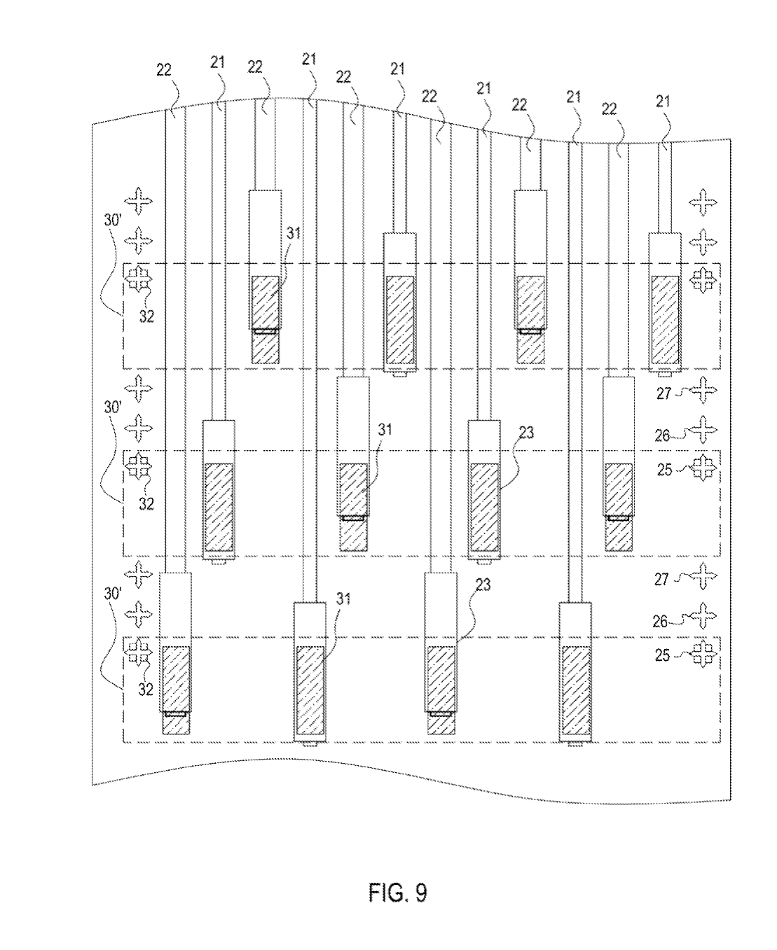

FIG. 9 is a schematic view of a line width difference of a third line configuration according to an embodiment of the present invention. Please refer to FIG. 9 together with FIG. 2 for ease of understanding. The difference between this embodiment and the previous embodiments lies in that, the lines of the panel 20 according to this embodiment adopt houndstooth arrangement with a plurality of layers, ends of lines in different groups are arranged in a staggered manner at two different lengths in each layer, and lines in each layer may correspond to an alignment film 30′ respectively. Here, by taking three layers as an example, the panel 20 is configured with a plurality of reference points, and each layer includes three groups of reference points (25, 26, 27) respectively.

As shown in FIG. 9, the average line width of the first group of lines 21 is smaller than that of the second group of lines 22, and thus the line impedance value of the first group of lines 21 may be higher than that of the second group of lines 22. Therefore, the processing unit 40 may control the setting unit 43 to simultaneously adjust displacement of alignment films 30′ corresponding to the three layers respectively, so as to enable two alignment marks 32 of each alignment film 30′ to simultaneously align with a first group of reference points 25 in each layer on the panel 20 and to enable a contact area between the line contact block 31 and the film contact unit 23 of the first group of lines 21 to be greater than that between the line contact block 31 and the film contact unit 23 of the second group of lines 22, so as to compensate for the line impedance value of the first group of lines 21.

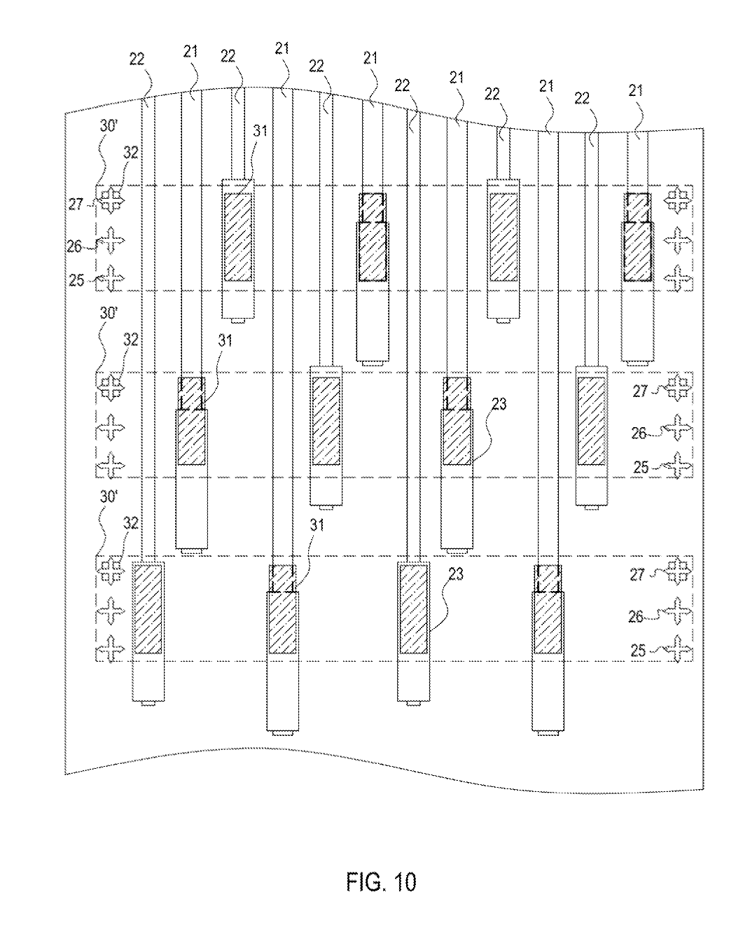

FIG. 10 is a schematic view of a second line width difference of the third line configuration according to an embodiment of the present invention. Please refer to FIG. 10 together with FIG. 2 for ease of understanding. In this embodiment, the houndstooth arrangement is also taken as an example for illustration.

As shown in FIG. 10, the average line width of the first group of lines 21 is greater than that of the second group of lines 22, and thus the line impedance value of the first group of lines 21 may be lower than that of the second group of lines 22. Therefore, the processing unit 40 may control the setting unit 43 to simultaneously adjust displacement of alignment films 30′ corresponding to the three layers respectively, so as to enable the two alignment marks 32 of each alignment film 30′ to simultaneously align with a third group of reference points 27 in each layer on the panel 20 and to enable the contact area between the line contact block 31 and the film contact unit 23 of the second group of lines 22 to be greater than that between the line contact block 31 and the film contact unit 23 of the first group of lines 21, so as to compensate for the line impedance value of the second group of lines 22.

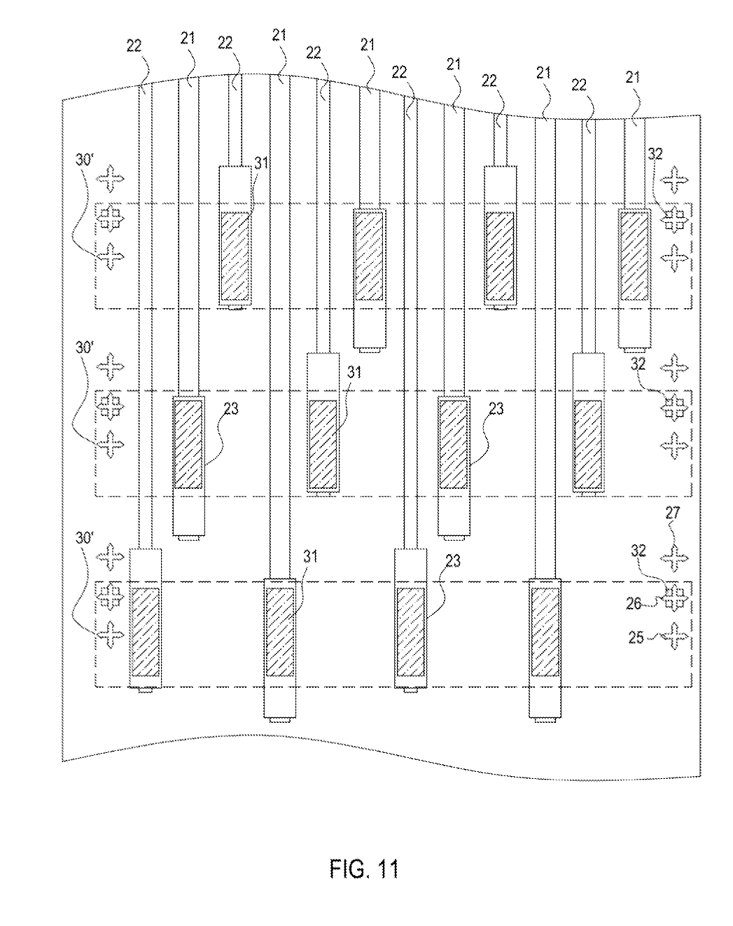

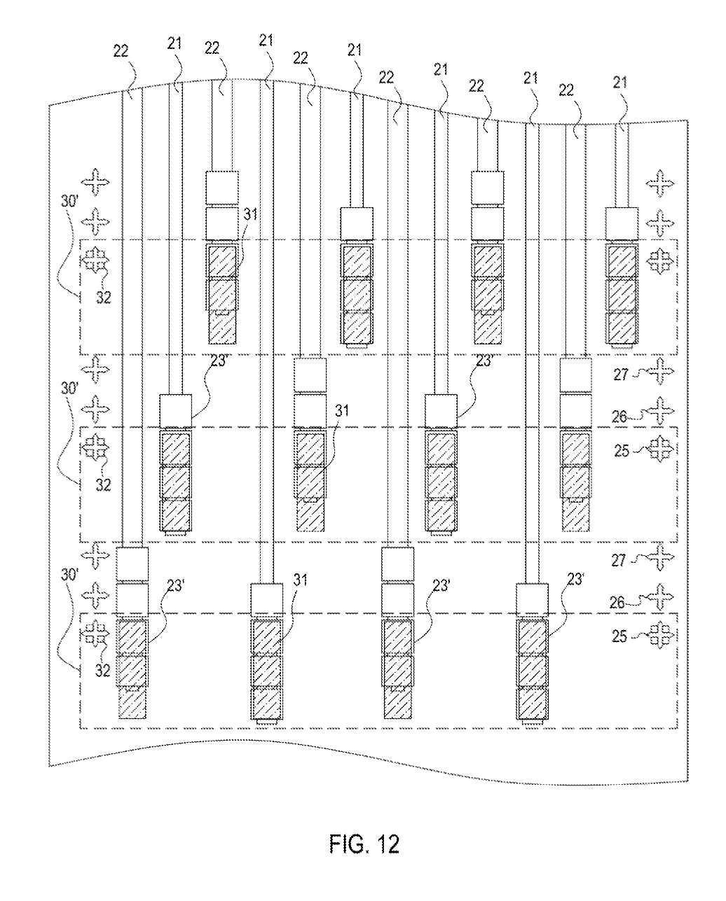

FIG. 11 is a schematic view of a third line width difference of the third line configuration according to an embodiment of the present invention. Please refer to FIG. 11 together with FIG. 2 for ease of understanding. In this embodiment, the houndstooth arrangement is also taken as an example for illustration.

Referring to FIG. 11, the average line width of the first group of lines 21 is equal to that of the second group of lines 22, or the line width difference between the average line width of the first group of lines 21 and the average line width of the second group of lines 22 is smaller than a set value, and the line impedance value of the first group of lines 21 may be equal to or close to that of the second group of lines 22. Therefore, the processing unit 40 may control the setting unit 43 to simultaneously adjust displacement of alignment films 30′ corresponding to the three layers respectively, so as to enable the two alignment marks 32 of each alignment film 30′ to simultaneously align with a second group of reference points 26 in each layer on the panel 20 and to enable the contact area between the line contact block 31 and the film contact unit 23 of the second group of lines 22 to be equal to that between the line contact block 31 and the film contact unit 23 of the first group of lines 21.

FIG. 12 is a schematic view of a first line width difference of a fourth line configuration according to an embodiment of the present invention. Please refer to FIG. 12 together with FIG. 2 for ease of understanding. In this embodiment, the houndstooth arrangement is also taken as an example for illustration, and the film contact units 23 include a plurality of spaced contact pads 23′.

Referring to FIG. 12, the average line width of the first group of lines 21 is smaller than that of the second group of lines 22, and thus the line impedance value of the first group of lines 21 may be higher than that of the second group of lines 22. Therefore, the processing unit 40 may control the setting unit 43 to simultaneously adjust displacement of alignment films 30′ corresponding to the three layers respectively, so as to enable the two alignment marks 32 of each alignment film 30′ to simultaneously align with the first group of reference points 25 in each layer on the panel 20 and to enable a contact area between the line contact block 31 and spaced contact pads 23′ of the first group of lines 21 to be greater than that between the line contact block 31 and spaced contact pads 23′ of the second group of lines 22. Referring to FIG. 12, in each layer, the line contact block 31 corresponding to the first group of lines 21 is in contact with three spaced contact pads 23′, and the line contact block 31 corresponding to the second group of lines 22 is in contact with two spaced contact pad 23′, so as to compensate for the line impedance value of the first group of lines 21.

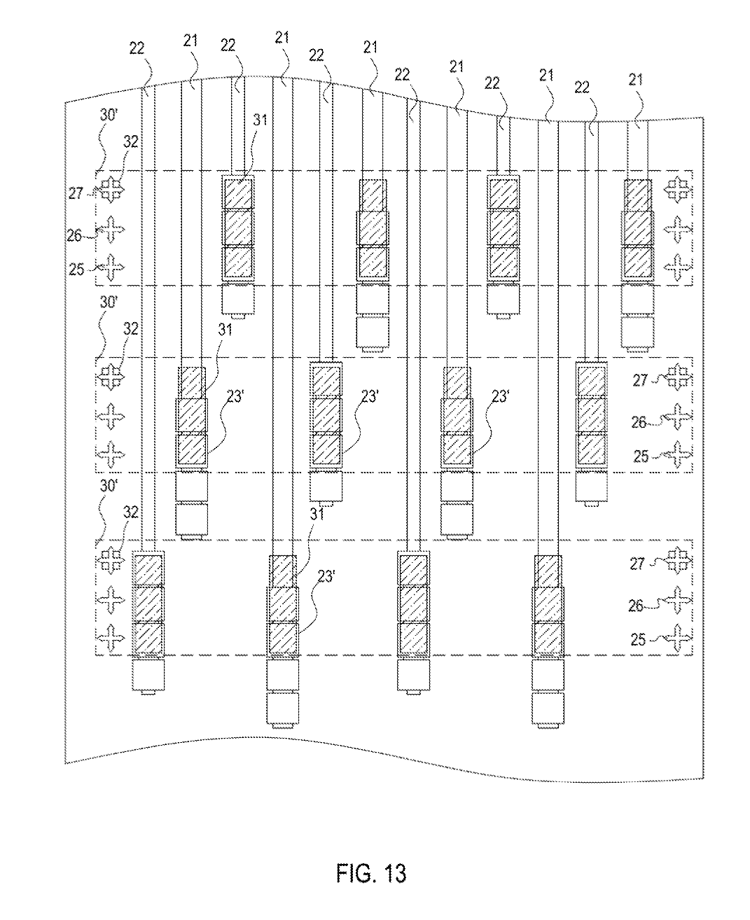

FIG. 13 is a schematic view of a second line width difference of the fourth line configuration according to an embodiment of the present invention. Please refer to FIG. 13 together with FIG. 2 for ease of understanding. In this embodiment, the houndstooth arrangement is also taken as an example for illustration, and the film contact units 23 include a plurality of spaced contact pads 23′.

Referring to FIG. 13, the average line width of the first group of lines 21 is greater than that of the second group of lines 22, and thus the line impedance value of the first group of lines 21 may be lower than that of the second group of lines 22. Therefore, the processing unit 40 may control the setting unit 43 to simultaneously adjust displacement of alignment films 30′ corresponding to the three layers respectively, so as to enable the two alignment marks 32 of each alignment film 30′ to simultaneously align with the third group of reference points 27 in each layer on the panel 20 and to enable a contact area between the line contact block 31 and spaced contact pads 23′ of the second group of lines 22 to be greater than that between the line contact block 31 and spaced contact pads 23′ of the first group of lines 21. Referring to FIG. 13, in each layer, the line contact block 31 corresponding to the first group of lines 21 is in contact with two spaced contact pads 23′, and the line contact block 31 corresponding to the second group of lines 22 is in contact with three spaced contact pad 23′, so as to compensate for the line impedance value of the second group of lines 22.

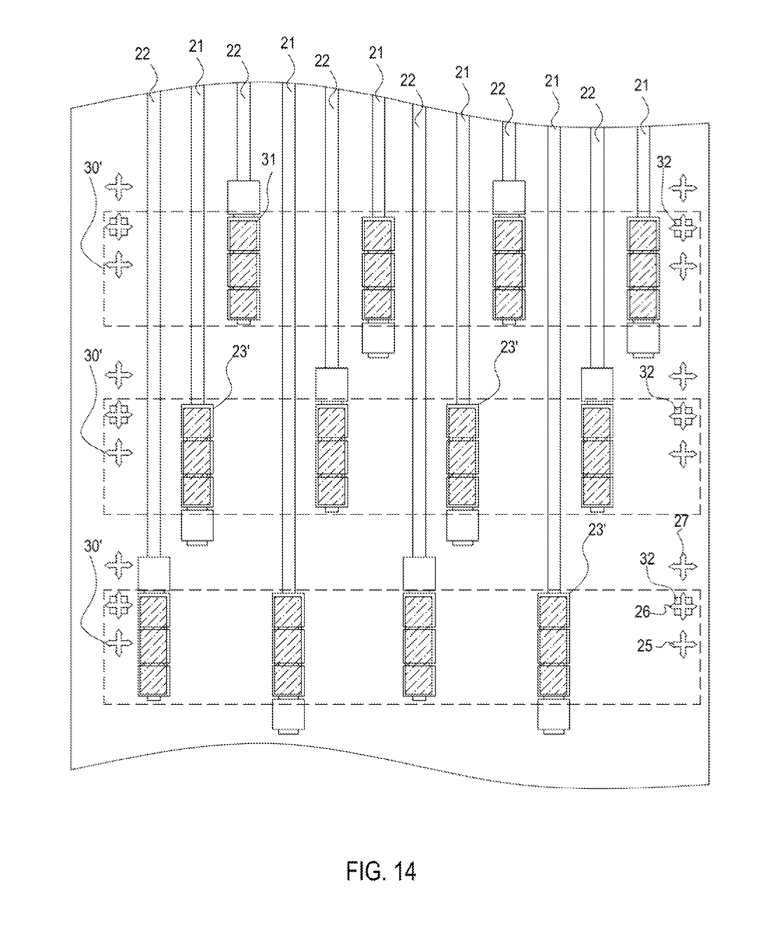

FIG. 14 is a schematic view of a third line width difference of the fourth line configuration according to an embodiment of the present invention. Please refer to FIG. 14 together with FIG. 2 for ease of understanding. In this embodiment, the houndstooth arrangement is also taken as an example for illustration, and the film contact units include a plurality of spaced contact pads 23′.

Referring to FIG. 14, the average line width of the first group of lines 21 is equal to that of the second group of lines 22, or the line width difference between the average line width of the first group of lines 21 and the average line width of the second group of lines 22 is smaller than a set value, and the line impedance value of the first group of lines 21 may be equal to or close to that of the second group of lines 22. Therefore, the processing unit 40 may control the setting unit 43 to simultaneously adjust displacement of the alignment films 30′ corresponding to the three layers respectively, so as to enable the two alignment marks 32 of each alignment film 30′ to simultaneously align with the second group of reference points 26 in each layer on the panel 20 and to enable a contact area between the line contact block 31 and spaced contact pads 23′ of the second group of lines 22 to be equal to that between the line contact block 31 and spaced contact pads 23′ of the first group of lines 21. Referring to FIG. 14, in each layer, the line contact block 31 corresponding to the first group of lines 21 is in contact with three spaced contact pads 23′, and the line contact block 31 corresponding to the second group of lines 22 is also in contact with three spaced contact pad 23′.

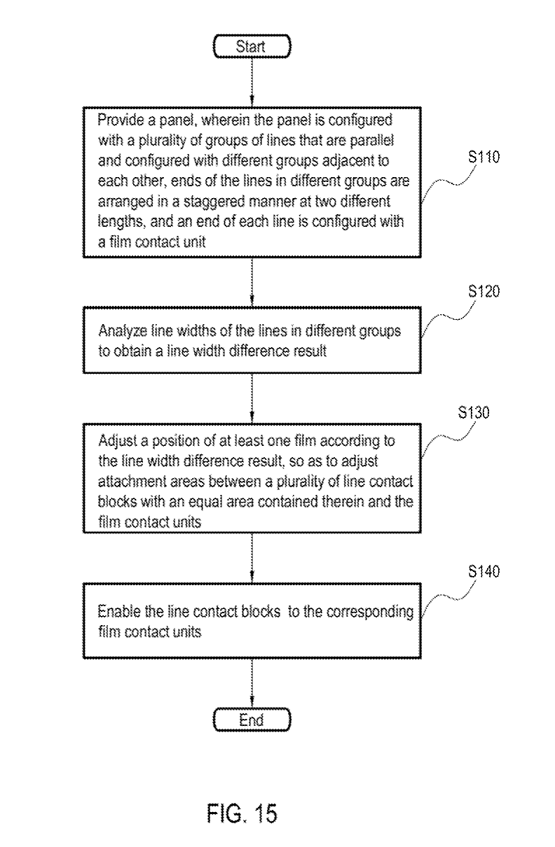

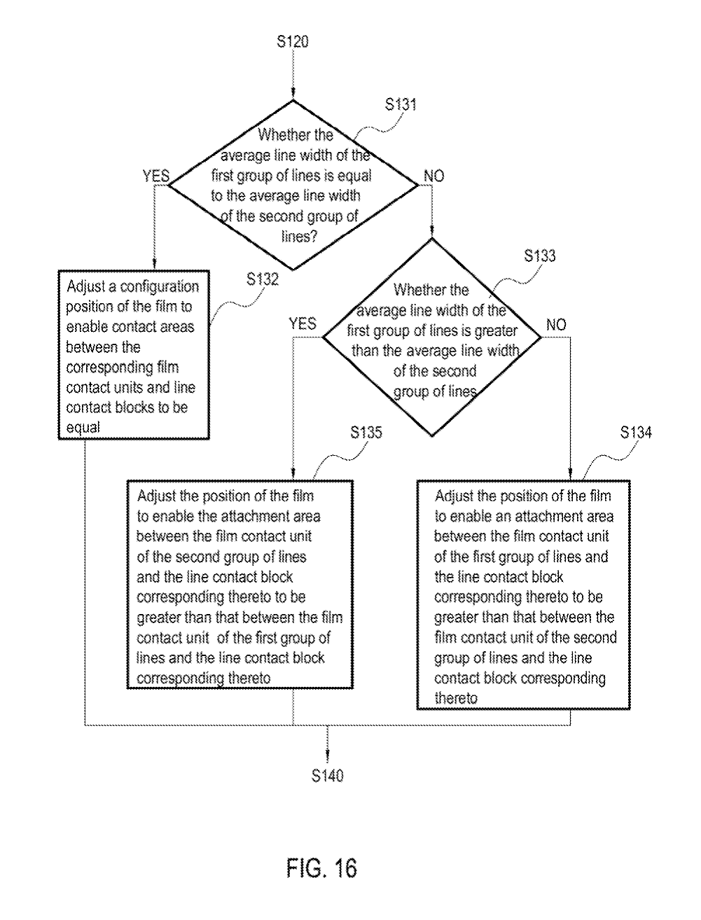

FIG. 15 is a detailed schematic flow chart of a method according to an embodiment of the present invention and FIG. 16 is a detailed schematic flow chart of a method according to an embodiment of the present invention. Referring to FIG. 15 and FIG. 16 together with FIG. 2 and FIG. 14 for ease of understanding, the method is illustrated as follows.

A panel is provided, in which the panel is configured with a plurality of groups of lines that are parallel and configured with different groups adjacent to each other, ends of the lines in different groups are arranged in a staggered manner at two different lengths, and an end of each line is configured with a film contact unit (Step S110). Referring to FIG. 3A, FIG. 4A, FIG. 5A, FIG. 6A, FIG. 7A, and FIG. 8A, the panel 20 is configured with a plurality of groups of lines that are parallel and configured with different groups adjacent to each other. Here, the first group of lines 21 and the second group of lines 22 are taken as an example for illustration, the lines arranged side by side in a row are taken as an example for illustration, and the end of each line is configured with a film contact unit 23. The panel 20 includes a plurality of reference points, and here, three groups of reference points (25, 26, 27) are taken as an example for illustration. The film 30 is configured with at least one group of alignment marks, and here, two alignment marks 32 are taken as an example for illustration. Referring to FIG. 9 to FIG. 14, the lines of the panel 20 also adopt the houndstooth arrangement with a plurality of layers, in each layer, ends of lines in different groups are arranged in a staggered manner at two different lengths, and lines in each layer may correspond to an alignment film 30′ respectively. By taking three layers as an example, the panel 20 is configured with a plurality of reference points, and each layer may correspond to three groups of reference points (25, 26, 27) respectively. The film contact unit 23 may be a single component or consist of a plurality of spaced contact pads 23′.

Line widths of the lines in different groups are analyzed to obtain a line width difference result (Step S120). As stated above, the photographing unit 41 is used for photographing configuration and alignment of the panel 20 and the film 30 to form an image. After obtaining an image provided by the photographing unit 41, the processing unit 40 analyzes line width differences of each group of lines of the panel in the image to form a line width difference result. The line width difference result includes analytic values of lines such as line width values and an average line width value of lines of the first group of lines 21 and line width values and an average line width value of lines of the second group of lines 22, and the line width difference calculation mode is also applicable to the houndstooth arrangement architecture illustrated in FIG. 9 to FIG. 14.

A position of at least one film is adjusted according to the line width difference result, so as to adjust attachment areas between a plurality of line contact blocks with an equal area contained therein and the film contact units (Step S130).

The processing unit 40 may calculate a displacement distance and a displacement direction of the film 30 according to the line width difference result. First, the processing unit 40 may determine whether the average line width of the first group of lines 21 is equal to the average line width of the second group of lines 22 or the line width difference therebetween is smaller than a set value (Step S131).

When the average line width of the first group of lines 21 is equal to the average line width of the second group of lines 22 or the line width difference therebetween is smaller than a set value, a configuration position of the film 30 is adjusted to enable contact areas between the corresponding film contact units 23 and line contact blocks 31 to be equal (Step S132).

Referring to FIG. 3A to FIG. 8B, the film 30 may be configured on the panel 20, the line contact blocks 31 corresponding to each other may be attached to the film contact units 23. In terms of the houndstooth arrangement architecture in FIG. 9 to FIG. 14, the alignment film 30′ in each layer is also configured with line contact blocks 31 having positions corresponding to the film contact units 23, so that the line contact blocks 31 of the alignment film 30′ in each layer are attached to the corresponding film contact units 23.

Referring to FIG. 5A and FIG. 5B, FIG. 8A and FIG. 8B, and FIG. 11 and FIG. 14, the average line width of the first group of lines 21 is equal to that of the second group of lines 22, or the line width difference between the average line width of the first group of lines 21 and the average line width of the second group of lines 22 is smaller than a set value, and the line impedance value of the first group of lines 21 is equal to or close to the line impedance value of the second group of lines 22. Therefore, the processing unit 40 may control the setting unit 43 to adjust displacement of a film 30, so as to enable two alignment marks 32 of the film 30 to align with a second group of reference points 26 of the panel 20 (for example, FIG. 5A and FIG. 5B, FIG. 8A and FIG. 8B), or to simultaneously adjust displacement of alignment films 30′ corresponding to multiple layers respectively, so as to enable the two alignment marks 32 of each alignment film 30′ to simultaneously align with the second group of reference points 26 in each layer on the panel (for example, FIG. 11 and FIG. 14), thus enabling the contact area between the line contact block 31 and the film contact unit 23 of the second group of lines 22 to be equal to that between the line contact block 31 and the film contact unit 23 of the first group of lines 21.

When determining that the average line width of the first group of lines 21 is not equal to that of the second group of lines 22 or the line width difference therebetween is higher than a set value, the processing unit 40 determines whether the average line width of the first group of lines 21 is greater than that of the second group of lines 22 (Step S133). When the average line width of the first group of lines 21 is smaller than that of the second group of lines 22, the position of the film 30 is adjusted to enable an attachment area between the film contact unit 23 of the first group of lines 21 and the line contact block 31 corresponding thereto to be greater than that between the film contact unit 23 of the second group of lines 22 and the line contact block 31 corresponding thereto (Step S134).

Referring to FIG. 3A and FIG. 3B, FIG. 6A and FIG. 6B, and FIG. 9 and FIG. 12, the average line width of the first group of lines 21 is smaller than that of the second group of lines 22, and thus the line impedance value of the first group of lines 21 may be higher than that of the second group of lines 22. Therefore, the processing unit 40 may control the setting unit 43 to adjust displacement of a single film 30, so as to enable two alignment marks 32 of the film 30 to align with a first group of reference points 25 of the panel 20 (for example, FIG. 3A and FIG. 3B, FIG. 6A and FIG. 6B), or to simultaneously adjust the displacement of alignment films 30′ corresponding to three layers respectively, so as to enable the two alignment marks 32 of each alignment film 30′ to simultaneously align with the first group of reference points 25 in each layer on the panel (for example, FIG. 9 and

FIG. 12), thus enabling the contact area between the line contact block 31 and the film contact unit 23 of the first group of lines 21 to be greater than that between the line contact block 31 and the film contact unit 23 of the second group of lines 22, so as to compensate for the line impedance value of the first group of lines 21.

When the average line width of the first group of lines 21 is greater than that of the second group of lines 22, the position of the film 30 is adjusted to enable the attachment area between the film contact unit 23 of the second group of lines 22 and the line contact block 31 corresponding thereto to be greater than that between the film contact unit 23 of the first group of lines 21 and the line contact block 31 corresponding thereto (Step S135).

Referring to FIG. 4A and FIG. 4B, FIG. 7A and FIG. 7B, FIG. 10, and FIG. 13, the average line width of the first group of lines 21 is greater than that of the second group of lines 22, and thus the line impedance value of the first group of lines 21 may be lower than that of the second group of lines 22. Therefore, the processing unit 40 may control the setting unit 43 to adjust displacement of a single film 30, so as to enable two alignment marks 32 of the film 30 to align with a third group of reference points 27 of the panel 20 (for example, FIG. 4A and FIG. 4B, FIG. 7A and FIG. 7B), or to simultaneously adjust the displacement of alignment films 30′ corresponding to three layers respectively, so as to enable the two alignment marks 32 of each alignment film 30′ to simultaneously align with the third group of reference points 27 in each layer on the panel (for example, FIG. 10 and FIG. 13), thus enabling the contact area between the line contact block 31 and the film contact unit 23 of the first group of lines 21 to be smaller than that between the line contact block 31 and the film contact unit 23 of the second group of lines 22, so as to compensate for the line impedance value of the second group of lines 22.

Finally, the film 30 is configured on the panel, so as to enable the line contact block 31 to be attached to the corresponding film contact unit 23 (Step S140).

The implementation modes or embodiments of the technical means for solving the problems according to the present invention have been described above, which are not intended to limit the present invention. Any equivalent change or modification made without departing from the concept of the present invention should fall within the scope of the present invention.

What is claimed is:

1. A panel conductive film configuration system, comprising:
a panel, configured with a plurality of groups of lines that are parallel and configured with different groups adjacent to each other, wherein ends of the lines in different groups are arranged in a staggered manner at two different lengths, and an end of each line is configured with a film contact unit;
a film, comprising a plurality of line contact blocks with an equal area;
a photographing unit, used for photographing the groups of lines to from an image;
a setting unit, used for being controlled to configure the film on the panel, so as to enable the line contact blocks to be attached to the film contact units; and
a processing unit, electrically connected to the photographing unit and the setting unit, analyzing line widths of the groups of lines according to the image to obtain a line width difference result, and controlling the setting unit according to the line width difference result, so as to adjust attachment areas between the line contact blocks and the film contact units.

2. The panel conductive film configuration system according to claim 1, wherein the groups of lines comprise a plurality of first lines and a plurality of second lines, the processing unit controls the setting unit to adjust a position of the film when determining that an average line width of the first lines is smaller than that of the second lines, so as to increase attachment areas between the film contact units of the first lines and the line contact blocks corresponding thereto, and the processing unit controls the setting unit to adjust the position of the film when determining that the average line width of the second lines is smaller than that of the first lines, so as to increase attachment areas between the film contact units of the second lines and the line contact blocks corresponding thereto.

3. The panel conductive film configuration system according to claim 1, wherein the groups of lines comprise a plurality of first lines and a plurality of second lines, the processing unit controls the setting unit to adjust a position of the film when determining that an average line width of the first lines is smaller than that of the second lines, so as to reduce attachment areas between the film contact units of the second lines and the line contact blocks corresponding thereto, and the processing unit controls the setting unit to adjust the position of the film when determining that the average line width of the second lines is smaller than that of the first lines, so as to reduce attachment areas between the film contact units of the first lines and the line contact blocks corresponding thereto.

4. The panel conductive film configuration system according to claim 1, wherein the processing unit controls the setting unit to adjust a position of the film, so as to enable contact areas between the film contact units and the line contact blocks to be equal when determining that the line widths of the lines in different groups are equal or a line width difference is smaller than a set value.

5. The panel conductive film configuration system according to claim 1, wherein the ends of the groups of lines are formed into houndstooth arrangement with a plurality of layers, ends of the groups of lines in different groups in each layer are arranged in a staggered manner at two different lengths, and the lines in each layer correspond to an alignment film respectively.

6. The panel conductive film configuration system according to claim 1, wherein each of the film contact units comprises a plurality of spaced contact pads, and the processing unit controls a number of spaced contact pads of the corresponding spaced contact pads in contact with the line contact blocks of lines in a corresponding same group when controlling the setting unit to adjust displacement of the film.

7. The panel conductive film configuration system according to claim 1, wherein the panel is configured with a plurality of groups of reference points, the film is configured with at least one group of alignment marks, and the processing unit analyzes alignment of the group of alignment marks and one of the groups of reference points according to pictures photographed by the photographing unit, so as to use the setting unit to control displacement of the film.

8. A panel conductive film configuration method, comprising:
providing a panel, wherein the panel is configured with a plurality of groups of lines that are parallel and configured with different groups adjacent to each other, ends of the lines in different groups are arranged in a staggered manner at two different lengths, and an end of each line is configured with a film contact unit;
analyzing line widths of the lines in different groups to obtain a line width difference result;
adjusting a position of at least one film according to the line width difference result to adjust attachment areas between a plurality of line contact blocks with an equal area contained therein and the film contact units; and
enabling the line contact blocks to be attached to the film contact units.

9. The panel conductive film configuration method according to claim 8, wherein the group of lines comprise a plurality of first lines and a plurality of second lines, and the step of adjusting a position of at least one film according to the line width difference result, so as to adjust attachment areas between a plurality of line contact blocks with an equal area contained therein and the film contact units comprises:
determining whether an average line width of the first lines is equal to that of the second lines or a line width difference is smaller than a set value; and
when an average line width of the first lines is equal to that of the second lines or a line width difference is smaller than a set value, adjusting a configuration position of the film to enable contact areas between the film contact units and the line contact blocks to be equal.

10. The panel conductive film configuration method according to claim 9, wherein the step of determining whether an average line width of the first lines is equal to that of the second lines or a line width difference is smaller than a set value further comprises:
when the average line width of the first lines is not equal to that of the second lines or the line width difference is higher than a set value, determining whether the average line width of the first lines is greater than that of the second lines, so as to decide a configuration position and a displacement direction of the film.

11. The panel conductive film configuration method according to claim 10, wherein a position of the film is adjusted to enable attachment areas between the film contact units of the second lines and the line contact blocks corresponding thereto to be greater than those between the film contact units of the first lines and the line contact blocks corresponding thereto when the average line width of the first lines is greater than that of the second lines.

12. The panel conductive film configuration method according to claim 10, wherein a position of the film is adjusted to enable attachment areas between the film contact units of the first lines and the line contact blocks corresponding thereto to be greater than those between the film contact units of the second lines and the line contact blocks corresponding thereto when the average line width of the first lines is smaller than that of the second lines.
